(19) United States
(12) Patent Application Publication
(10) Pub. No.: US 2026/0141099 A1
(43) Pub. Date: May 21, 2026

(54) Dynamic User Impersonation for Enhanced Data Security and Access Control

(71) Applicant: SAP SE, Walldorf (DE)

(72) Inventors: Artur Finger Durao Branco, Porto Alegre (BR); Pedro Ziebell, Porto Alegre (BR); Ioannis Kostis, Heidelberg (DE); Cedric Hedin, Houilles (FR); Robert Adlington, Levallois-Perret (FR); Tizian Gross, Mannheim (DE)

(73) Assignee: SAP SE, Walldorf (DE)

(21) Appl. No.: 18/954,212

(22) Filed: Nov. 20, 2024

(51) Int. Cl. G06F 21/62

(52) U.S. Cl. CPC G06F 21/6218

(57) ABSTRACT

The present disclosure relates to dynamic user impersonation to enhance data security and access control in computing environments, such as to allow the configuration and operation of data access controls for one user to be verified by another user. A first identifier value of a user to be impersonated is received and is assigned to a user impersonation variable in a data store. A query associated with a second identifier value of a different user is received, accessing data objects subject to data access controls. The query is executed using the first identifier value to filter requests according to the specified data access controls, and filtered query results are returned. In some cases, the first identifier value is provided as an input parameter to a data object subject to data access controls. In other cases, the first identifier value is set as a session variable for a data store session.

### FIELD

The present disclosure generally relates data access controls implemented in a data store, such as a database.

### BACKGROUND

Data access controls (DACs) are mechanisms used in software systems, particularly enterprise systems, to manage and restrict access to data based on various criteria, such as a user's identity, role, or specific permissions. DACs are often used in environments where multiple users, departments, or organizations share access to a common dataset. Often, it is desired to provide a user with access only to data which is required for their role in an organization. This can help the employee perform their role more effectively, as the data that is specifically relevant to them is retrieved and processed. For example, if a user has a role in North American operations, the user might be presented with irrelevant data or inaccurate results if data retrieval operations on behalf of the user also retrieve data from European operations. Further, access controls prevent users from viewing or potentially manipulating data that is not relevant to their role. These types of restrictions are particularly useful when some data may be confidential or subject to other security requirements, such as restrictions on the use of personal information.

Typically, DACs are implemented in both the application layer, where permissions are defined and managed, and the database layer, where these permissions are enforced during query execution. By applying filters or access policies to database queries, DACs prevent unauthorized users from accessing sensitive data while allowing legitimate users to view the information relevant to their role. In practice, DACs are widely used in industries that handle sensitive information, such as healthcare, finance, and large corporate environments, where strict data governance and compliance with privacy regulations are required.

In traditional systems that implement data access control (DAC), administrators often face significant challenges when managing and verifying user permissions due to the limitations of their own user profiles. That is, if an administrator is trying to verify whether access controls for a particular user are working correctly, the administrator will see data that they are authorized to see, not data that would be seen by the user. Even when an administrator has elevated or superuser access, they are frequently restricted to viewing data based on their personal permissions, making it difficult to simulate or verify how other users experience access to the system. This limitation poses a number of problems, particularly in the context of troubleshooting and ensuring that access control mechanisms are correctly enforced.

One issue is that administrators are unable to fully test or troubleshoot access issues for users with more restricted permissions. For example, if a regular user encounters a problem accessing a specific dataset or experiences unexpected behavior due to their access controls, the administrator cannot directly replicate the user's experience. Instead, the administrator is forced to rely on secondhand reports or attempt to manually apply filters that simulate the user's perspective, which may not accurately reflect the enforced access rules. This inability to directly observe the system from the user's perspective creates inefficiencies in troubleshooting and increases the likelihood of unresolved access control problems.

Another problem arises when administrators need to verify that permissions are correctly configured for various roles or individual users. In complex enterprise environments, access control policies are often customized for different roles or departments, requiring granular enforcement of permissions across a wide range of users. Administrators are tasked with verifying that these policies are correctly applied. However, with only their own access profile available, they cannot easily verify how different users' permissions interact with the data. Superuser access allows visibility into all data, but it does not enable the administrator to view data as it would appear to users with restricted access. This makes it difficult to confirm that permissions are functioning as intended, particularly when managing complex access hierarchies, such as those involving role-based access controls or multi-level permissions schemes.

Additionally, administrators often encounter difficulties when attempting to configure or adjust permissions settings for new or existing users. Without the ability to preview data from a restricted user's perspective, there is no simple way to confirm that the applied permissions will result in the desired access restrictions or privileges. This leads to trial-and-error workflows, where permissions must be iteratively adjusted based on user feedback or testing results, rather than through direct verification at the time of configuration. Such inefficiencies not only waste administrative time but also increase the risk of inadvertent misconfigurations that could expose sensitive data or block legitimate access.

These limitations in traditional DAC systems hinder the ability of administrators to effectively manage and verify access controls, particularly in environments with complex or dynamic permissions. The lack of direct visibility into how permissions are applied from the perspective of different users introduces friction in the management process and increases the likelihood of both security vulnerabilities and operational disruptions. As a result, there is a need for improved access control mechanisms that allow administrators to simulate user perspectives, verify permissions settings, and troubleshoot access issues in a more streamlined and effective manner.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

The present disclosure relates to dynamic user impersonation to enhance data security and access control in computing environments, such as to allow the configuration and operation of data access controls for one user to be verified by another user. A first identifier value of a user to be impersonated is received and is assigned to a user impersonation variable in a data store. A query associated with a second identifier value of a different user is received, accessing data objects subject to data access controls. The query is executed using the first identifier value to filter requests according to the specified data access controls, and filtered query results are returned. In some cases, the first identifier value is provided as an input parameter to a data object subject to data access controls. In other cases, the first identifier value is set as a session variable for a data store session.

In one aspect, the present disclosure provides a process of performing user impersonation for data access controls during query execution. A first identifier value of a first user to be impersonated is received. The first identifier value is assigned to a user impersonation variable in a data store.

A query is received, the query accessing one or more data objects subject to data access controls, where the query is associated with a second identifier value of a user issuing the query. The second identifier value is different from the first identifier value. The query is executed, where the executing includes using the first identifier value to filter query requests using data access controls specified for the first identifier value. Filtered query results are returned in response to the query.

The present disclosure also includes computing systems and tangible, non-transitory computer-readable storage media configured to carry out, or includes instructions for carrying out an above-described method. As described herein, a variety of other features and advantages can be incorporated into the technologies as desired.

### BRIEF DESCRIPTION OF THE DRAWINGS

FIG. 1 is a diagram of a computing environment in which disclosed techniques can be implemented.

FIG. 2 is a diagram illustrating multiple schemas and a relationship between data object in the schemas, where at least a portion of data objects in the schema are subject to data access controls.

FIG. 3 illustrates a command to create a protected view that accepts an input parameter for a user to be impersonated, a command to create a table function that accesses a permissions object to determine data access information for a user associated with a query of the protected view, and a command to retrieve information from the protected view using user impersonation.

FIG. 4 illustrates a command to define a typical table function that provides data access control for a protected view but does not support user impersonation, and further illustrates a command to define a table function according to the present disclosure that supports user impersonation and accesses a session variable to determine whether user impersonation has been requested and an identifier of a user to be impersonated.

FIG. 5 illustrates a command to define a table function that provides data access control for a protected view that allows for user impersonation, but includes a check to determine whether user impersonation is authorized.

FIG. 6 illustrates a command to define a table function that returns a user identifier to be used in determining data access controls for a protected view.

FIG. 7 illustrates a command to define a table function that determines data access controls for a user identifier provided by calling the table function of FIG. 6.

FIG. 8 is a timing diagram illustrating operations in executing a query using user impersonation, where user impersonation is requested at an application in communication with a data store where the query is executed.

FIGS. 9A and 9B illustrate example code that can be used in implementing the operations depicted in FIG. 8.

FIG. 10 is a flowchart of operations of a process of performing user impersonation for data access controls during query execution.

FIG. 11 is a diagram of an example computing system in which some described embodiments can be implemented.

FIG. 12 is an example cloud computing environment that can be used in conjunction with the technologies described herein.

### DETAILED DESCRIPTION

### Example—Overview

Data access controls (DACs) are mechanisms used in software systems, particularly enterprise systems, to manage and restrict access to data based on various criteria, such as a user's identity, role, or specific permissions. DACs are often used in environments where multiple users, departments, or organizations share access to a common dataset. Often, it is desired to provide a user with access only to data which is required for their role in an organization. This can help the employee perform their role more effectively, as the data that is specifically relevant to them is retrieved and processed. For example, if a user has a role in North American operations, the user might be presented with irrelevant data or inaccurate results if data retrieval operations on behalf of the user also retrieve data from European operations. Further, access controls prevent users from viewing or potentially manipulating data that is not relevant to their role. These types of restrictions are particularly useful when some data may be confidential or subject to other security requirements, such as restrictions on the use of personal information.

Typically, DACs are implemented in both the application layer, where permissions are defined and managed, and the database layer, where these permissions are enforced during query execution. By applying filters or access policies to database queries, DACs prevent unauthorized users from accessing sensitive data while allowing legitimate users to view the information relevant to their role. In practice, DACs are widely used in industries that handle sensitive information, such as healthcare, finance, and large corporate environments, where strict data governance and compliance with privacy regulations are required.

In traditional systems that implement data access control (DAC), administrators often face significant challenges when managing and verifying user permissions due to the limitations of their own user profiles. That is, if an administrator is trying to verify whether access controls for a particular user are working correctly, the administrator will see data that they are authorized to see, not data that would be seen by the user. Even when an administrator has elevated or superuser access, they are frequently restricted to viewing data based on their personal permissions, making it difficult to simulate or verify how other users experience access to the system. This limitation poses a number of problems, particularly in the context of troubleshooting and ensuring that access control mechanisms are correctly enforced.

One issue is that administrators are unable to fully test or troubleshoot access issues for users with more restricted permissions. For example, if a regular user encounters a problem accessing a specific dataset or experiences unexpected behavior due to their access controls, the administrator cannot directly replicate the user's experience. Instead, the administrator is forced to rely on secondhand reports or attempt to manually apply filters that simulate the user's perspective, which may not accurately reflect the enforced access rules. This inability to directly observe the system from the user's perspective creates inefficiencies in troubleshooting and increases the likelihood of unresolved access control problems.

Another problem arises when administrators need to verify that permissions are correctly configured for various roles or individual users. In complex enterprise environments, access control policies are often customized for different roles or departments, requiring granular enforcement of permissions across a wide range of users. Administrators are tasked with verifying that these policies are correctly applied. However, with only their own access profile available, they cannot easily verify how different users' permissions interact with the data. Superuser access allows visibility into all data, but it does not enable the administrator to view data as it would appear to users with restricted access. This makes it difficult to confirm that permissions are functioning as intended, particularly when managing complex access hierarchies, such as those involving role-based access controls or multi-level permissions schemes.

Additionally, administrators often encounter difficulties when attempting to configure or adjust permissions settings for new or existing users. Without the ability to preview data from a restricted user's perspective, there is no simple way to confirm that the applied permissions will result in the desired access restrictions or privileges. This leads to trial-and-error workflows, where permissions must be iteratively adjusted based on user feedback or testing results, rather than through direct verification at the time of configuration. Such inefficiencies not only waste administrative time but also increase the risk of inadvertent misconfigurations that could expose sensitive data or block legitimate access.

These limitations in traditional DAC systems hinder the ability of administrators to effectively manage and verify access controls, particularly in environments with complex or dynamic permissions. The lack of direct visibility into how permissions are applied from the perspective of different users introduces friction in the management process and increases the likelihood of both security vulnerabilities and operational disruptions. As a result, there is a need for improved access control mechanisms that allow administrators to simulate user perspectives, verify permissions settings, and troubleshoot access issues in a more streamlined and effective manner.

The present disclosure provides techniques that allow for “user impersonation”, which allows one user to use the access credentials of another user in place of their normally assigned access credentials. For example, a customer support representative can use the identifier of a user whose access configurations are of interest in place of their normally assigned identifiers.

In one example, data objects subject to DACs can be configured to accept an additional input parameter, representing an identifier of a user to impersonate. If a value for the input parameter is provided, that user identity will be used, otherwise the user's actual identifier will be used. This approach can be particularly useful in relatively small schemas or schemas where there are comparatively few data objects subject to DACs, as the process of redefining the views to accept the input parameter can be time consuming and potentially result in database downtime, thus also affecting consuming applications. This approach can also be useful when a new database schema is being developed, as data objects associated with a DAC can be defined from the beginning to use the additional input parameter.

Issues related to the complexity of modifying existing data objects can be mitigated by, rather than modifying a data object, temporarily materializing DAC protected data objects, such as database views, and having the input parameters defined for those temporarily materialized data objects. For example, a materialized view can be created for use during impersonation for support purposes, and then the materialized views can be removed when the support work has been completed.

In another implementation, a variable of a database session context can be used to store an identifier of a user to be impersonated. A DAC, such as one implemented using a table function, can be defined to check if a value has been set for the session context variable. If so, the user's identifier will be replaced with the identity of the user to be impersonated. Otherwise, the user's actual identity is used.

Impersonation, by definition, is a circumvention of data access controls. While this can be a useful feature, it can also raise security concerns. Accordingly, a check can be implemented to determine whether a user requesting impersonation has sufficient access rights. In a particular implementation, if impersonation is requested and the user does not have rights, the impersonation request is simply ignored, and requests are processed using the user's actual identity. Controls can be specified at a more granular level, such as where some users may have the rights to impersonate other users in a particular schema but not others, while other types of users may have impersonation rights across all available schemas.

### Example—Example Computing Environment for Implementing Data Access Controls

FIG. 100 illustrates an example computing environment 100 in which disclosed techniques can be implemented. The computing environment 100 includes an application 104 that communicates with a database 108. A plurality of users, such as users 112, 114 can access the application 104, and thereby also access the database 108, or in some cases can directly access the database. Each user 112, 114 is associated with a user identifier 116. The user identifier 116 can be used in determining what data of the database 108 a user 112, 114 has access to.

The application 104 includes a data access control configuration component 120. Authorized users or computing processes can use the data access control configuration component 120 to define or update data access controls, such as to define to which data the users 112, 114 will have access to. A data access control definitions repository 128 includes data access controls defined with the data access control configuration component 120. In this case, a table 130 associates particular user identifiers with a particular role. For example, there may be a user role of regional sales manager, where users with this role are able to access data associated with a particular geographic region. There may be another user role of global sales manager, where users in this role have access to data from all geographic regions.

Table 132 illustrates how user roles can be associated with particular data access restrictions. The table 132 has a column for a user role and a column for a condition, such as a selection condition (serving as a data filter) for the user role. In this case, user role “A” may reflect a sales manager for “Region A”, and the selection condition results in data only being retrieved when the region is region A. User role “B” may reflect a global sales manager, and so the associated condition results in data being selected for all regions.

The application 104 may itself be subject to data access controls. For example, the database 108 can store data in a number of different schemas (also referred to as “spaces”). The application 104 can have a schema access key 136. The database 108 can include schema permissions 140, such as having a column for schema key value and a column for schema identifiers to which a particular schema key value has access. Note that a given value for the schema access key 136 can have access to one schema or to multiple schemas.

The database 108 can store data access control definitions 148. The data access control definitions 148 can be based on the data access definitions of the data access definitions repository 128, and are shown as being implemented in an analogous manner, including a table 152 that associates users with roles and selection conditions.

As an example of how data access controls can be implemented, consider a table 160 storing unprotected data. In this case, the table 160 has an identifier column, a region column, and an amount column (such as an amount of sales for a particular region value and a particular identifier value). Typically, a data access control can be implemented in part using a protected view 164. The protected view 164 contains a selection clause that retrieves data from the table 160, which contains unprotected data. The protected view 164 restricts the data retrieved from the table 160 to that permitted by data access controls, which in this case is achieved by calling a data access control in the form of a table function 168. The table function 160 includes a selection from the table 152. The table function 168 uses the user identifier 116 for a user associated with a data request in accessing the table 152, and returns to the protected view a table that includes the values of the regions to which the user has access. For example, querying the table 152 for “User 123” would return a value of “A”, while querying the table for “User 456” would return a value of “*”.

Authorization information is typically maintained for a connection between the application 104 and the database 108. For example, a global session variable typically includes an identifier for a database user associated with the connection. Typically, the database user is an application or technical user who has access rights to one or more schemas in the database 108. A number of application users, such as the users 112, 114 access the database through the same database session user, and typically there is additional context information for a session that provides an identifier for a particular application user associated with requests.

As an example, software available from SAP SE, of Walldorf, Germany, includes a session user identifier. The database user identifier can be retrieved using a SESSION_USER function call.

The database 108 can also maintain an application user context. In SAP technologies, this can be the XS_APPLICATIONUSER variable that stores an identifier of the application user, such as one derived from a JSON web token (JWT) of the user. This application user context can also be considered as “global”, but in a different way than the SESSION_USER. That is, the SESSION_USER is global across the database connection, including all application users accessing the database through the session user. The application user context is global in the sense that it is available to multiple data objects of the database, but there can be many concurrent application user contexts, each associated with a different value for XS_APPLICATION USER.

Database session context variables can be set using a command such as:
SET ‘MY_SESSIONVARIABLE’=‘some_value’;
   Values of the session context variables can be retrieved using a command such as:
SELECT SESSION_CONTEXT(‘MY_SESSION_VARIABLE’) FROM DUMMY;
   In the command, “DUMMY” can represent a virtual table that contains no data, and is used to comply with SQL syntax. A query processor 178 of the database 108 can be programmed to fetch information from a session context object when a select statement includes “SESSION_CONTEXT”. In an implementation using products of SAP SE, of Walldorf, Germany, such as using the HANA database, current application user information can also be bound to the database session using context variables, so it can be accessed from a session using a command such as:
SELECT SESSION_CONTEXT(‘XS_APPLICATIONUSER’) FROM DUMMY;

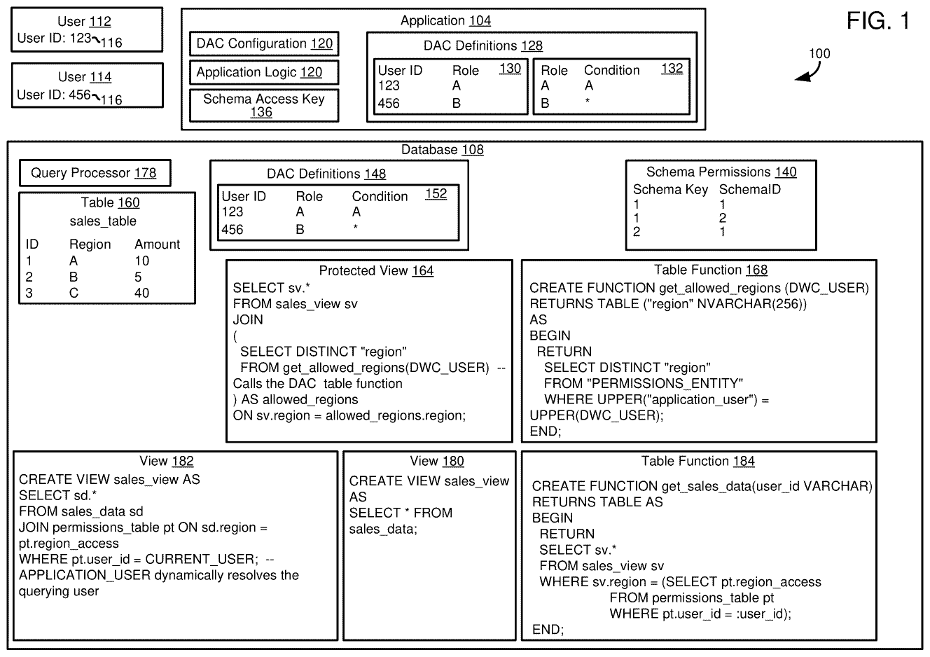

Rather than selecting data directly from the table 160, a protected view can select data from a view, where the view is defined with respect to one or more tables. This scenario is illustrated in FIG. 1, where a view 180 selects data from the table 160. In turn, a protected view 182 is used to access the view 180, and call a table function 184 to determine data to which a user has access.

### Example 3—Example Schema With Views and Data Access Controls for Views

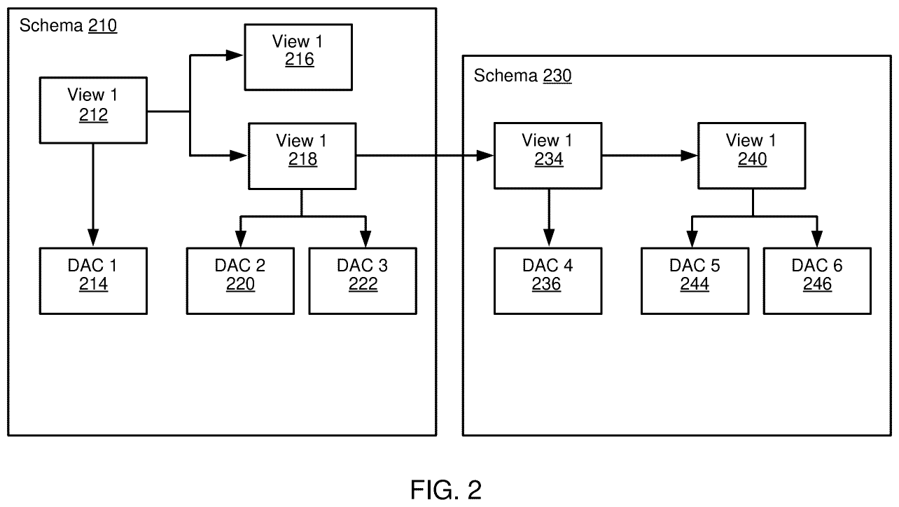

FIG. 2 provides a high-level depiction of interactions between a schema 210 and a schema 230. The schema 210 includes a view 212 that is subject to a single data access control 214, a view 216 that is not subject to data access controls, and a view 218 that is subject to a data access control 220 and a data access control 222.

The view 218 in turn references a view 234 in the schema 230. The view 234 is subject to a data access control 236, and references a view 240, which is associated with data access controls 244, 246.

FIG. 2 illustrates how an initial query, such as of the view 212, can involve data access controls at “downstream” views. In order to appropriately enforce data access controls, information used to evaluate the data access control 214, such as a user identifier, is typically propagated to downstream objects.

FIG. 2 also illustrates how a single data access request can involve requests to multiple schemas. In some cases, permission for a user in the schema 210 may differ from permissions for the user in the schema 230. Thus, some users may only have access to data in schema 210 or schema 230, while other users may have access to data in both schemas.

### Example 4—Example User Impersonation Using Alternative Data Object Definitions

Generally, disclosed techniques provide for user impersonation by manipulating an identifier of a user in the application user session context. Thus, rather than using the actual identifier of the user, such as a support user, for queries, the identifier of the impersonator is used.

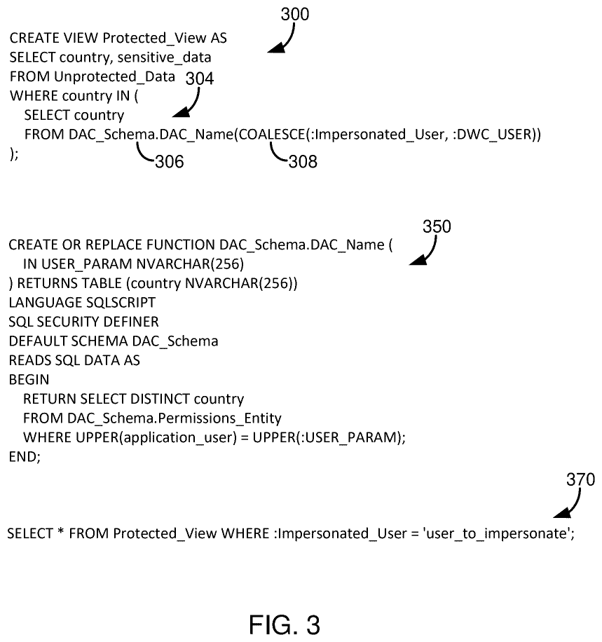

In the approach of this Example 4, protected views are written to accept an optional input parameter that provides an identifier of a user to be impersonated. An example protected view definition 300 is provided in FIG. 3. In the view definition 300, filter operations 304 are used to select countries that a specified user is authorized to access data for. The permissions object, storing user identifiers and associated allowed countries, is accessed at 306. The user identifier is resolved using the COALESCE operator at 308. The COALESCE operator returns the first non-null values in a list of values.

At 308, the COALESCE operator first analyzes the “Impersonated_User” input parameter, and then the value of the user identifier from the application user session context. Thus, if impersonation is to be used, and an impersonation user ID is provided, “Impersonated_User” will be non-null, and so the identifier of the impersonated user will be provided to the data access control, such as the table function 350. If no impersonated user is specified, the presence of the null value will cause the COALESCE operator to resolve to the user identifier of the application user context, since that is the first non-null value.

FIG. 3 also includes an example query 370 of the protected view that requests user impersonation, by providing a value of the user identifier of the user to be impersonated in a filter clause. In this case, a variable “user_to_impersonate” provides the user identifier, but in other cases the user identifier can be passed as a literal.

A downside to this approach is that it can require a substantial number of protected views to be rewritten to accept the input parameter. This can be time consuming, and can potentially cause issues due to complex dependencies between views. Changes to the protected views themselves can involve substantial testing efforts to confirm functionality works as intended, which can lead to unacceptable downtime for the relevant schema. Further, to the extent materialized views are used, changing the view definition can cause the view to be re-materialized, which involves additional processing resources.

Typically, user impersonation, such as for support purposes, is a comparatively minor use case for protected views. Accordingly, rather than modifying existing views, when impersonation is desired, a new, alternative view can be created that includes the input parameter. Downstream views can similarly be replaced by alternate views, which are referenced by the alternate upstream view rather than the original downstream view. These views can be dropped once impersonation operations have been completed, such as after return of query results for an impersonation query.

However, the creation of these alternate views can also be time and resource intensive, particularly if any of the views are materialized. Further, since the protected view calls the table function, the above approach may not be compatible with other types of data access controls. For example, data access controls that are based on Boolean evaluations or hierarchies use a structured filter framework in SAP HANA, where the structured filter framework calls an appropriate table function, rather than the protected view directly invoking the table function.

### Example 5—Example User Impersonation Through Session Variable

This Example 5 describes another technique for implementing user impersonation. Rather than modifying protected views, the technique modifies the data access controls, such as a table function, to evaluate an application user session context variable. For example, a command can be executed to set the variable, $$DAC_IMPERSONATION$$, such as:
SET ‘$$DAC_IMPERSONATION$$’=‘<user_to_impersonate’>.
   This session variable can be available to all data objects, and queries thereof, including both relational queries or analytical queries.

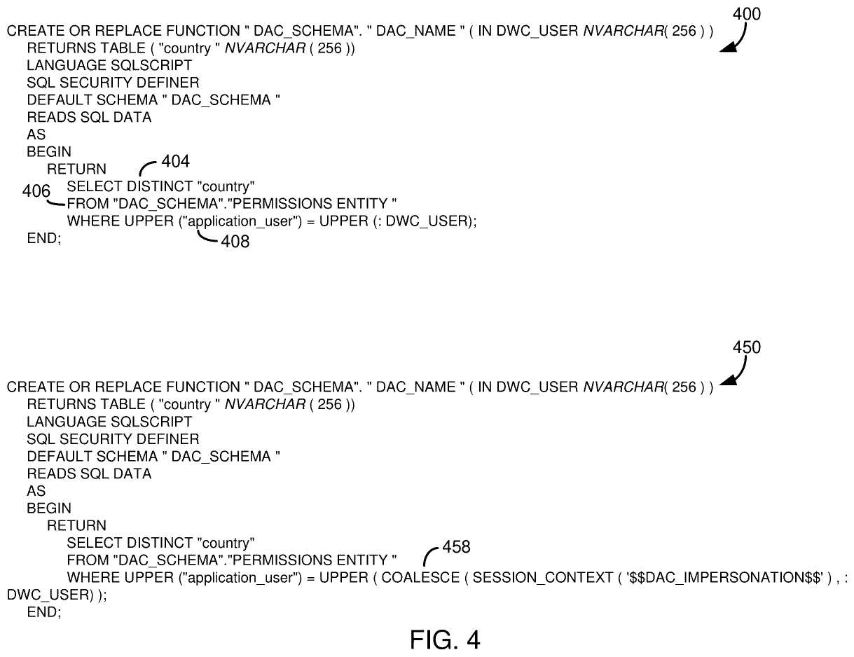

FIG. 4 provides an example 400 of a typical table function used for data access controls. In this case, lines 404, 406, 408 retrieve countries whose data is available to particular users, where the user is specified as “DWC_USER”, which corresponds to the user identifier for the application user session context.

FIG. 4 also provides an example 450 of a table function according to disclosed techniques. The table function 450 is generally similar to the table function 400. However, similar to the protected view definition 300 of FIG. 3, the table function uses the COALESCE operator at 458 to select the first non-null value from the user impersonation variable ($$DAC_IMPERSONATION$$) and the value of the user identifier for the application user session context. Thus, if user impersonation is desired, and an identifier of a user to impersonate has been set for $$DAC_IMPERSONATION, this will be the first non-null value, and the identifier of the user to be impersonated will be used in retrieving permissions information from a permissions entity. If user impersonation has not been requested, and no value is provided for $$DAC_IMPERSONATION$$, $ $DAC_IMPERSONATION$$ will be evaluated as null by the COALESCE operator, which will then use the user identifier for the application user session context in evaluating a permissions entity.

Modifying the data access controls, such as a table function, to implement impersonation can provide various benefits as with compared to modifying protected views. For example, while data objects, such as protected views, which are protected using a table function may have complex dependencies, the table functions themselves do not. Table functions can also be more stable, in the sense of being modified less frequently than the protected views. Table functions can also service multiple views, further reducing duplicative efforts. For example, if a table function determines values for a country attribute to which a user has access, that table function can be used with any protected view where the country attribute is an attribute used to define restrictions.

### Example 6—Example Checking of Authorizations Prior to Performing User Impersonation

Various modifications can be made to the technique of Example 5. While the technique of Example 5 is effective, it can be problematic in that any user with SQL access to the database can set the impersonation variable ($$DAC_IMPERSONATION$$). That is, user access to the database can be restricted to predefined queries that are executed, such as in response to a user's interaction with a graphical user interface. Access can be further restricted such that some users only can read data, while other users can both read and write (which includes updates and deletions) data. Other users may be given full access to the database, such as to execute arbitrary SQL operations or to set database parameters. It may be desirable to further limit the ability of even users with full SQL access to use user impersonation.

In one implementation, this more secure implementation can be achieved by modifying the table function to both check to see if user impersonation has been requested, and whether the user requesting impersonation (such as based on the actual user identifier of the application user context) has permission to use the impersonation feature In an example, authorized users are either support users or a schema owner. Both of these can be role-based permissions, such as where a user identifier in the application user context is associated with a support user role or a schema owner role. In some cases, support user roles can be restricted to users of entities that operate the database, including in multi-tenant databases. For support users, greater impersonation rights might be granted, such as to all schemas associated with the database.

Schema owners, also referred to as space owners, are users who have been given expanded access rights to particular schemas in the database. For example, an application might have multiple schemas, used in different application operational scenarios. Schema owners can include administrators (such as IT or database administrators), “power” end users who have more responsibility for a schema and sufficient technical knowledge to, for example, modify the schema, or at least understand more technical details of the schema, or project managers, who can be a type of “power” user.

In a specific implementation, a schema owner is a technical user to which only a software application itself has access. For example, a particular software application may only have rights to access data in certain schemas, and not others. In this scenario, access rights of individual users of the software application can be evaluated prior to a request being sent to the database. The application determines whether an application user is entitled to perform impersonation, and then the database determines whether the application has access rights to the relevant schema, and where impersonation is only allowed in schemas where the application is a schema owner.

Impersonation rights for schema owners can be limited to the particular schemas for which the user serves as a schema owner. For example, User 1 might be a schema owner for Schema A, and User 2 might be a schema owner for Schema B. User 1 could perform impersonation for data objects in Schema A, but not in Schema B. Similarly, User 2 could perform impersonation for data objects in Schema B, but not in Schema A.

Referring back to FIG. 2, support users may be provided with access to schemas 210 and 230, while schema owners may have access to both schemas, or a single schema depending on their specific permissions.

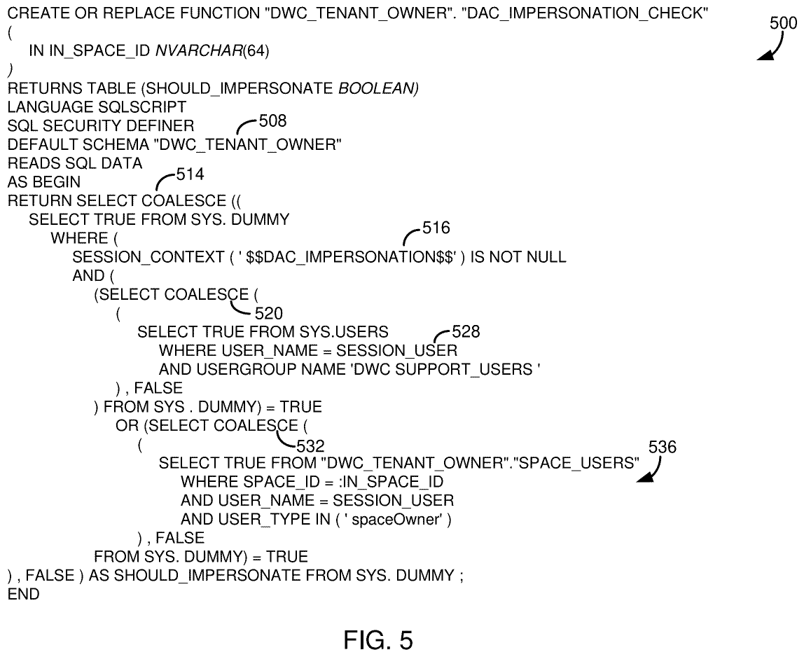

FIG. 5 provides an example table function definition 500 that checks to see if a user is authorized to use an impersonation feature, including with respect to a particular schema. The table function 500 returns a Boolean value (SHOULD_IMPERSONATE) indicating whether impersonation is allowed for a given user and schema.

At line 508, the table function definition 500 sets a default schema, which may correspond to a schema associated with a particular tenant in a multi-tenant environment. The default schema can be selected based on tenant-specific information provided in, or retrievable through, data associated with a request to establish a session between an application and a database. The default schema can indicate what schema should be used when operations do not otherwise indicate a specific schema.

At line 514, the COALESCE operator is used to select the first non-null Boolean value from either of various permission checks or a default value of FALSE. That is, if checks described below indicate that the user requesting impersonation is a support user or a schema owner, a value of TRUE will be returned, and be the value returned when the table function definition 500 is executed. Otherwise, the default value of FALSE is used as the return value.

Line 516 checks to confirm a value has been provided for the impersonation variable storing an identifier of the user to impersonate. If not, the COALESCE operator can return a value of FALSE, indicating that impersonation is not authorized (or in this case, more accurately, that impersonation was not requested). At line 520, another COALESCE operator returns the first non-null value of TRUE or FALSE, where TRUE is returned, and FALSE otherwise, if the session user (which can be a database session user or an application session user, depending on implementation) is found in a group of users who serve as support users. The check as to whether the user is a support user is implemented at line 528.

The table function 500 uses another COALESCE operator at line 532 to indicate whether a user is a schema owner (referred to here as a space owner). The check of whether the user (which again, depending on implementation can be a database session user or an application session user) is in a list of identified space owners for the particular schema in which impersonation is to be performed (provided through the IN_SPACE_ID variable) is implemented at line 536. If the user is a space owner, the check at line 532 returns TRUE, and FALSE otherwise.

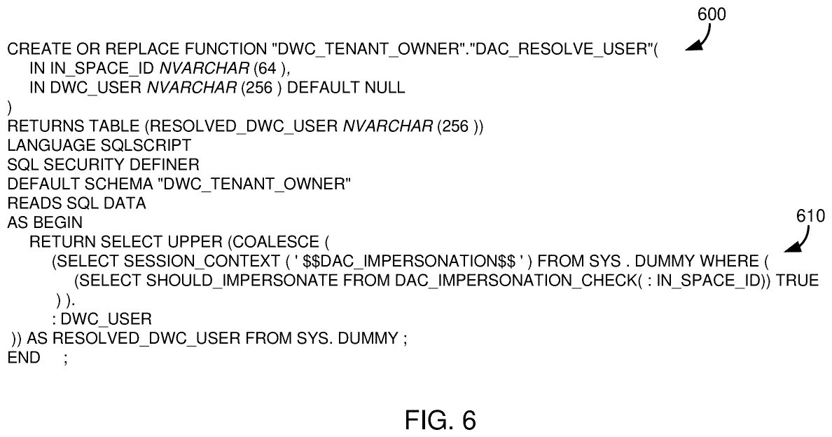

FIG. 6 provides a table function 600 that determines whether to use the identifier of the application session user or an identifier of a user to be impersonated during processing of protected data. At lines 610, the table function 600 uses the COALESCE operator to select the first non-null value from the identifier of the user to be impersonated, if a call to the table function definition 500 returns TRUE, or the user from the application session context otherwise.

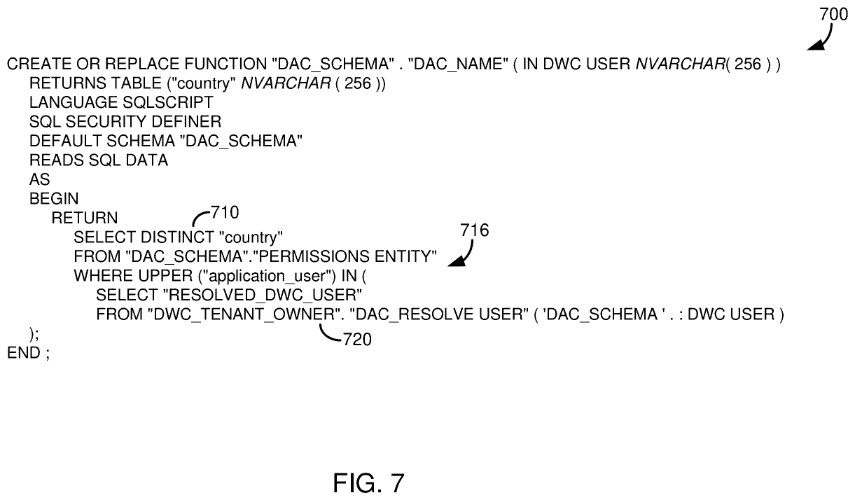

FIG. 7 provides a table function 700 that retrieves permission information for protected data objects. Line 710 selects countries for which a user has access privileges. Line 720 of a selection condition 716 calls the table function 600 to determine the user identifier to be used in the permission check, which is then used in the selection condition 716 to retrieve the appropriate permissions for the protected view (such as the list of countries associated with the projection attribute, “country,” of line 710).

### Example 7—Example User Impersonation Initiated at a Software Application in Communication With a Data Store

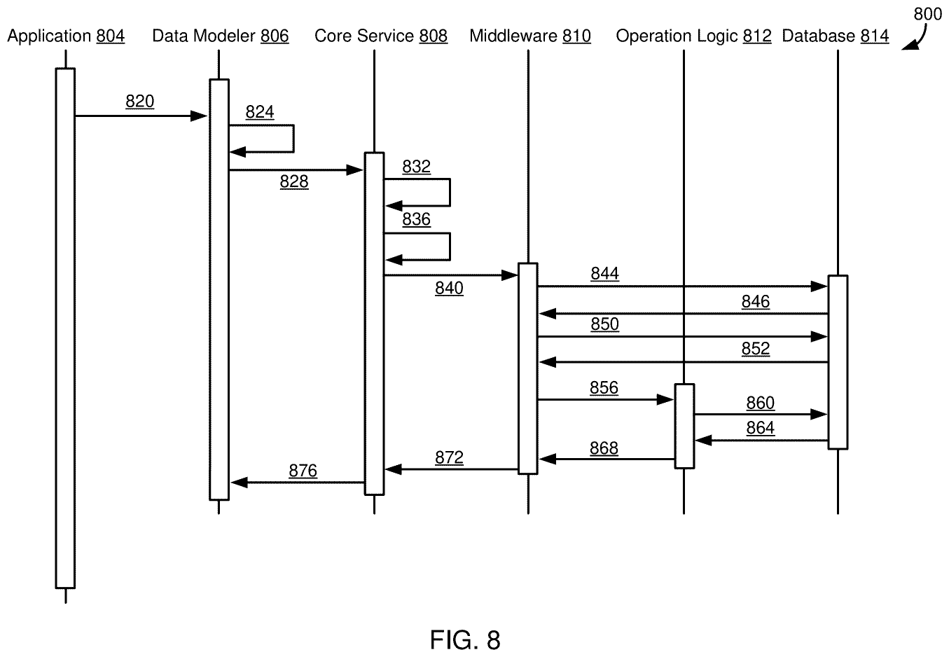

The technique described in Examples 5 and 6 can be particularly useful when a user, such as a schema owner or a support user, has direct database access and can, for example, use a SQL console to set the user impersonation variable to an identifier of a user to be impersonated. FIG. 8 is a timing diagram illustrating how the user impersonation check can be performed based on requests initiated at a software application having a session with a database. In a particular implementation, the application can provide functionality to “preview” data, and the impersonation logic can be used with the data preview functionality.

The timing diagram 800 illustrates the sequence of interactions between various components involved in the user impersonation process, where the user impersonation is requested at an application, rather than being requested directly in a database. In a particular example, components of the timing diagram 800 can be components of SAP DATASPHERE or DATA WAREHOUSE CLOUD.

The process of the timing diagram 800 is implemented by an application 804, such as an application that receives user requests, and where operations performed by the application correspond with user requests. The application 804 communicates with a data modeler component 806, such as DATA BUILDER of SAP SE, of Walldorf, Germany, specifying the identifier of the user to be impersonated. The impersonation requests from the data modeler component are processed by a core service 808, which verifies permissions and forwards a data request, with impersonation and the identifier of the user to be impersonated, to a middleware component 810. The middleware component 810, such as SAP DATA INTEGRATION SERVICE, establishes a connection to a database 814, such as SAP HANA, and sets the impersonated user identifier as a session variable, as described in Examples 5 and 6. A business logic layer 812, such as the SAP CLOUD APPLICATION PROGRAMMING (CAP) service, is invoked by the middleware component 810 to execute the business logic and query the database 814, retrieving the requested data. The various operations in the timing diagram 800 will now be discussed in further detail.

A user sends a request 820, through the application 804, to preview data in the database 814. The request 820 is sent from the application 804 to the data modeler 806. The request 820 includes an identifier of the user to be impersonated. At 824, the data modeler 806 processes the request 820 by adding the impersonated user identifier to a header. This header is a part of the request metadata that carries additional information used in processing the request 820. Specifically, the header encapsulates an impersonation context, including the identifier of the impersonated user, such that correct user permissions are applied when accessing the data to accomplish the desired impersonation. The header is used to pass the identifier of the impersonated user though the various components involved in handling the request 820.

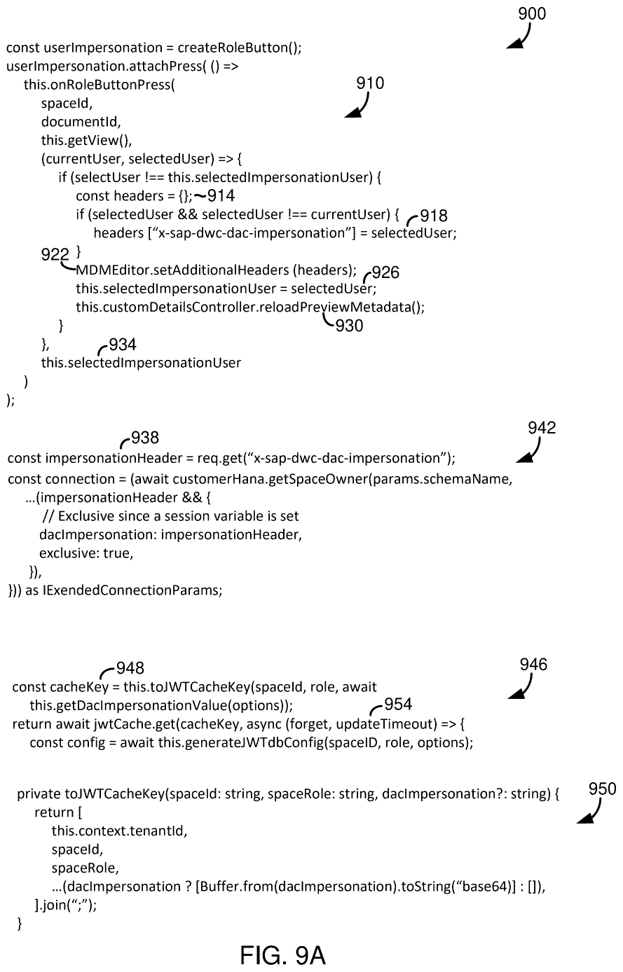

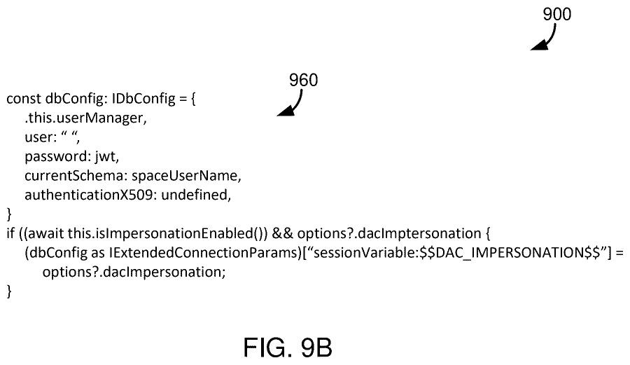

FIGS. 9A and 9B present code 900 that can be used in implementing disclosed techniques, particularly regarding the timing diagram 800. In code segment 910, an onRoleButtonPress event handler is responsible for handling the impersonation request. The parameters spaceId, documentId, and this.getView() are used to provide context for the request, such as identifying the specific space and document being accessed, and the current view in the application. These parameters are used so that the impersonation request is correctly associated with the relevant data and user interface components.

The code segment 910 initializes an empty headers object at line 914. If a user is selected for impersonation and this user is different from the current user, the selected user ID is added to the headers object with the key “x-sap-dwc-dac-impersonation” at line 918. This header is then set using the MDMEditor.setAdditionalHeaders(headers) method of line 922, which attaches the header to the request, so that the impersonation context is included in the request metadata.

In line 926, the this.selectedImpersonationUser property is updated to store the selected user ID. The this.customDetailsController.reloadPreviewMetadata() method is called at line 930 to refresh the data preview, applying the new impersonation context.

The final this.selectedImpersonationUser property of line 934 is used to keep track of the currently selected impersonation user. This allows the application 904 to determine if the impersonation context has changed and to update the headers and reload the data preview accordingly. This mechanism results in the data preview reflecting the permissions of the impersonated user, enabling administrators and support users, or other authorized individuals or computing processes, to debug and verify row-level security policies effectively.

Returning to FIG. 8, the data modeler 806 sends a communication 828 to the core service 808, where the communication includes the header with the identifier of the user to be impersonated. The core service 808 is responsible for handling core data access and security operations within an execution environment, such as SAP DATASPHERE. The core service 808 is responsible for setting the correct user context to be applied when accessing protected data of the database 814. The core service 808 processes the communication 828, verifies permissions at 832 (such as that the user requesting impersonation is authorized to perform impersonation operations, and where checks for this issue can be included at the database level, as previously described). The permissions can be those stored in the data access control definitions in the tables 130, 132 of the application 104 of FIG. 1, where FIG. 1 is a simplified representation that does not break out components such as the data modeler 806 or the core service 808.

The core service 808 receives the communication 828 and extracts the impersonated user ID from the header using req.get(“x-sap-dwc-dac-impersonation) at line 938 of code 942 of the code 900 of FIG. 9A.

The core service 808, such as in response to determining that the user submitting the request 820 is authorized to perform user impersonation, adds the impersonated user identifier to a data transfer object (DTO) at 836. A DTO is an object that encapsulates and carries data between processes. In this timing diagram 800, the DTO includes the impersonated user identifier.

Regarding the operations at 832 and 836, in FIG. 9A, code 942 illustrates a customerHana.getSpaceOwner function being called with the schema name to be accessed and the impersonation header. If the impersonation header is present, it is included in the parameters, such using the DTO, with the key dacImpersonation, and the request is marked as exclusive, allowing a database session variable for impersonation to be set correctly. Marking the request as exclusive results in the session variable for impersonation being handled in isolation, preventing interference from other concurrent operations, and maintaining the correct user context throughout the data access process.

Returning again to FIG. 8, after the core service 808 processes the communication 828 and verifies the permissions, it communicates with the middleware component 810 through a communication 840, which includes the DTO. The middleware component 810, in some implementations, can be associated with the SAP DATA INTEGRATION SERVICE, which manages data requests and responses between the user interface and backend services for products of SAP.

The middleware 810 receives the communication 840 from the core service 808, which includes the impersonated user identifier encapsulated in the request metadata, via the DTO. The middleware 810 is responsible for managing the interactions with the database 814, including setting the correct user context to be applied when accessing the data. This involves opening a connection to the database 814 at 844, where a response (such as a success or failure response) 846 is received. At 850, the middleware 810 communicates with the database 814 to set the impersonated user identifier as a session variable, such as using previously described techniques. A response 852 is sent from the database 814 to the middleware 810, such as a response that indicates whether the session variable was successfully set.

In implementing the operations at 844 and 850, code 900 of FIG. 9A can be used. In particular, for operations at 844, in code 946, line 948 declares a unique cache key that is based on the tenant ID, space ID, role, and the base64-encoded impersonation, which is generated using the toJWTCacheKey function of code 950.

Code 954 connects to the database 814 and checks to see if the generated cache key exists in the cache. If the cache key does not exist, the generateJWTdbConfig function is called to create a new JWT configuration, which is then stored in the cache with the generated cache key.

For operations at 850, code 960 of FIG. 9B is used to set the $ $DAC_IMPERSONATION$$ session variable before executing a query. This code 960 configures the database connection parameters using the dbConfig object. The dbConfig object includes parameters such as the user manager, user, password (JWT), current schema, and authentication method. If impersonation is enabled and an impersonation value is provided in the options, the session variable $$DAC_IMPERSONATION$$ is set to the impersonated user ID. This allows the impersonation context to be correctly applied during the database operations.

Returning to FIG. 8, once the connection is established and the session variable is set, the middleware 810 invokes the operation logic at 856 to execute the query. The operation logic 812 sends the query to the database 814 at 860, to be processed using the impersonated user context.

The database 814 executes the query and returns the result to the operation logic 812 at 864. The operation logic 812 then returns the result to the middleware at 868, which then forwards the results to the core service 808 at 872, which in turn sends the data to the data modeler 806 at 876 to be displayed.

### Example 8—Example Operations

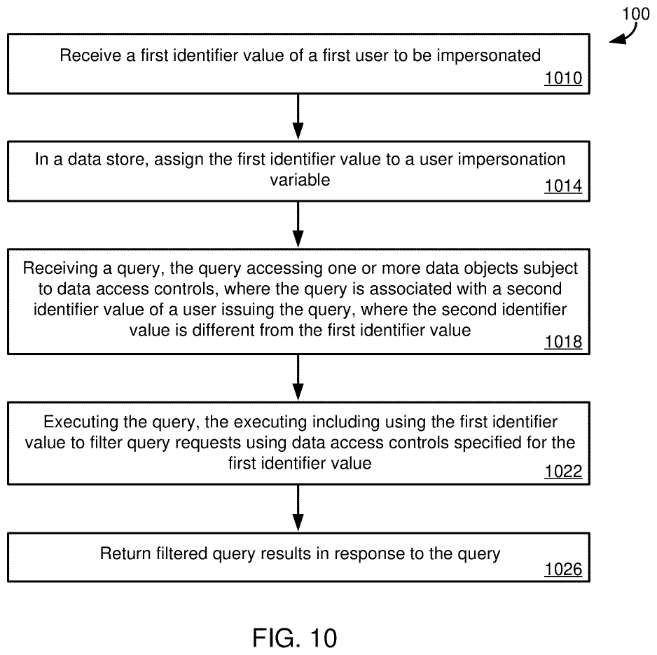

FIG. 10 provides a flowchart of a process 1000 of performing user impersonation for data access controls during query execution. At 1010, a first identifier value of a first user to be impersonated is received. The first identifier value is assigned to a user impersonation variable in a data store at 1014.

At 1018, a query is received, the query accessing one or more data objects subject to data access controls, where the query is associated with a second identifier value of a user issuing the query. The second identifier value is different from the first identifier value. The query is executed at 1022, the executing includes using the first identifier value to filter query requests using data access controls specified for the first identifier value. Filtered query results are returned in response to the query at 1026.

### Example 913 Additional Examples

Example 1 is a computing system that includes at least one memory, one or more hardware processor units coupled to the at least one memory, and one or more computer-readable storage media storing computer-executable instructions that cause the computing system to perform various operations. The operations include receiving a first identifier value of a first user to be impersonated and assigning the first identifier value to a user impersonation variable in a data store. A query is received that accesses one or more data objects subject to data access controls, where the query is associated with a second identifier value of a user issuing the query, and where the second identifier value is different from the first identifier value. The query is executed by using the first identifier value to filter query requests using data access controls specified for the first identifier value, and filtered query results are returned in response to the query.

Example 2 is the computing system of Example 1, where the data access controls specified for the first identifier value specify one or more values for an attribute of a data object of the one or more data objects.

Example 3 is the computing system of Example 1 or Example 2, where the operations further include providing the first identifier value as an input parameter to a data object of the one or more data objects.

Example 4 is the computing system of Example 3, where the operations further include, based on receiving the first identifier value, instantiating the data object of the one or more data objects that comprises the input parameter from a data object that does not comprise the input parameter.

Example 5 is the computing system of any of Examples 1-3, where the operations further include establishing a session between an application and the data store, wherein the user impersonation variable is a session variable.

Example 6 is the computing system of Example 5, where the session provides an application user context.

Example 7 is the computing system of any of Examples 1-6, where the operations further include providing the first identifier value to a data access control object, querying a permissions object by the data access control object to determine the data access controls specified for the first identifier value, and returning data access parameters of the permissions object for the first identifier value to be used in executing the query by the data access control object.

Example 8 is the computing system of any of Examples 1-7, where the data access control object is a table function.

Example 9 is the computing system of any of Examples 1-8, where the assigning of the first identifier value is performed through a direct data store command.

Example 10 is the computing system of any of Examples 1-9, where the operations further include, prior to filtering query results using data access controls specified for the first identifier, determining that a user associated with the second identifier value is authorized to cause the query to be executed by filtering query results using the first identifier value instead of the second identifier value.

Example 11 is the computing system of any of Examples 1-10, where determining that a user associated with the second identifier value is authorized to cause the query to be executed by filtering query results using the first identifier value includes determining that the user associated with the second identifier value is a schema owner or is a support user.

Example 12 is the computing system of Example 11, where at least a first data object of the one or more data objects accessed by the query is located in a first schema and at least a second data object of the one or more data objects accessed by the query is located in a second schema different from the first schema, and where executing the query includes using the first identifier value only for data objects in a schema for which the user associated with the second identifier value is a schema owner.

Example 13 is the computing system of Example 11 or Example 12, where at least a first data object of the one or more data objects accessed by the query is located in a first schema and at least a second data object of the one or more data objects accessed by the query is located in a second schema different from the first schema, and where executing the query comprises using the first identifier value for all data objects of the one or more data objects.

Example 14 is the computing system of any of Examples 1-13, where the operations further include, at an application in communication with the data store, setting the first identifier value and adding the first identifier value to a header. The first identifier value is extracted from the header. The first identifier value is used in establishing a connection between the application and the data store.

Example 15 is the computing system of Example 14, where using the first identifier value in establishing a connection between the application and the data store includes setting a value of a session variable for the connection.

Example 16 is a method implemented in a computing system comprising at least one hardware processor and at least one memory coupled to the at least one hardware processor. The method includes receiving a first identifier value of a first user to be impersonated. The first identifier value is assigned to a user impersonation variable in a data store. A query is received that accesses one or more data objects subject to data access controls, where the query is associated with a second identifier value of a user issuing the query, and where the second identifier value is different from the first identifier value. The query is executed by using the first identifier value to filter query requests using data access controls specified for the first identifier value, and filtered query results are returned in response to the query.

Example 17 is the method of Example 16, further including providing the first identifier value as an input parameter to a data object of the one or more data objects, and based on receiving the first identifier value, instantiating the data object of the one or more data objects that include the input parameter from a data object that does not include the input parameter.

Example 18 is the method of Example 16 or Example 17, further including establishing a session between an application and the data store, where the user impersonation variable is a session variable.

Example 19 is one or more non-transitory computer-readable storage media comprising computer-executable instructions that, when executed by a computing system comprising at least one hardware processor and at least one memory coupled to the at least one hardware processor, cause the computing system to receive a first identifier value of a first user to be impersonated. The one or more non-transitory computer-readable storage media also include instructions that cause computing system to assign the first identifier value to a user impersonation variable in a data store. A query is received that accesses one or more data objects subject to data access controls, where the query is associated with a second identifier value of a user issuing the query, and where the second identifier value is different from the first identifier value. The query is executed by using the first identifier value to filter query requests using data access controls specified for the first identifier value, and filtered query results are returned in response to the query.

Example 20 is the one or more computer-readable storage media of Example 19, further including computer-executable instructions that, when executed by the computing system, cause the computing system to establish a session between an application and the data store, wherein the user impersonation variable is a session variable.

### Example 10—Computing Systems

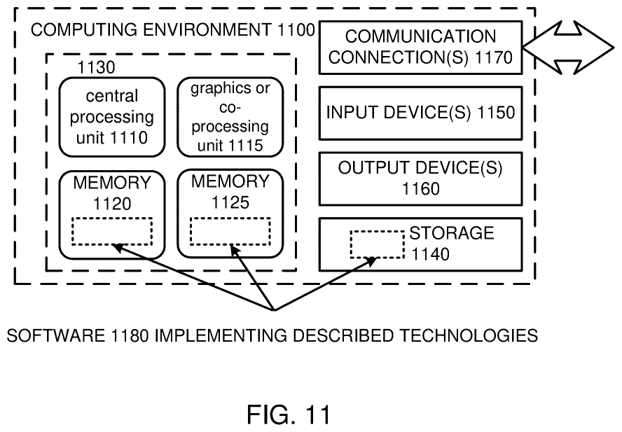

FIG. 11 depicts a generalized example of a suitable computing system 1100 in which the described innovations may be implemented. The computing system 1100 is not intended to suggest any limitation as to scope of use or functionality of the present disclosure, as the innovations may be implemented in diverse general-purpose or special-purpose computing systems.

With reference to FIG. 11, the computing system 1100 includes one or more processing units 1110, 1115 and memory 1120, 1125. In FIG. 11, this basic configuration 1130 is included within a dashed line. The processing units 1110, 1115 execute computer-executable instructions, such as for implementing a database environment, and associated methods, described in Examples 1-9. A processing unit can be a general-purpose central processing unit (CPU), a processor in an application-specific integrated circuit (ASIC), or any other type of processor. In a multi-processing system, multiple processing units execute computer-executable instructions to increase processing power. For example, FIG. 11 shows a central processing unit 1110 as well as a graphics processing unit or co-processing unit 1115. The tangible memory 1120, 1125 may be volatile memory (e.g., registers, cache, RAM), non-volatile memory (e.g., ROM, EEPROM, flash memory, etc.), or some combination of the two, accessible by the processing unit(s) 1110, 1115. The memory 1120, 1125 stores software 1180 implementing one or more innovations described herein, in the form of computer-executable instructions suitable for execution by the processing unit(s) 1110, 1115.

A computing system 1100 may have additional features. For example, the computing system 1100 includes storage 1140, one or more input devices 1150, one or more output devices 1160, and one or more communication connections 1170. An interconnection mechanism (not shown) such as a bus, controller, or network interconnects the components of the computing system 1100. Typically, operating system software (not shown) provides an operating environment for other software executing in the computing system 1100, and coordinates activities of the components of the computing system 1100.

The tangible storage 1140 may be removable or non-removable, and includes magnetic disks, magnetic tapes or cassettes, CD-ROMs, DVDs, or any other medium which can be used to store information in a non-transitory way, and which can be accessed within the computing system 1100. The storage 1140 stores instructions for the software 1180 implementing one or more innovations described herein.

The input device(s) 1150 may be a touch input device such as a keyboard, mouse, pen, or trackball, a voice input device, a scanning device, or another device that provides input to the computing system 1100. The output device(s) 1160 may be a display, printer, speaker, CD-writer, or another device that provides output from the computing system 1100.

The communication connection(s) 1170 enable communication over a communication medium to another computing entity, such as another database server. The communication medium conveys information such as computer-executable instructions, audio or video input or output, or other data in a modulated data signal. A modulated data signal is a signal that has one or more of its characteristics set or changed in such a manner as to encode information in the signal. By way of example, and not limitation, communication media can use an electrical, optical, RF, or other carrier.

The innovations can be described in the general context of computer-executable instructions, such as those included in program modules, being executed in a computing system on a target real or virtual processor. Generally, program modules or components include routines, programs, libraries, objects, classes, components, data structures, etc. that perform particular tasks or implement particular abstract data types. The functionality of the program modules may be combined or split between program modules as desired in various embodiments. Computer-executable instructions for program modules may be executed within a local or distributed computing system.

The terms “system” and “device” are used interchangeably herein. Unless the context clearly indicates otherwise, neither term implies any limitation on a type of computing system or computing device. In general, a computing system or computing device can be local or distributed, and can include any combination of special-purpose hardware and/or general-purpose hardware with software implementing the functionality described herein.

For the sake of presentation, the detailed description uses terms like “determine” and “use” to describe computer operations in a computing system. These terms are high-level abstractions for operations performed by a computer, and should not be confused with acts performed by a human being. The actual computer operations corresponding to these terms vary depending on implementation.

### Example 11—Cloud Computing Environment

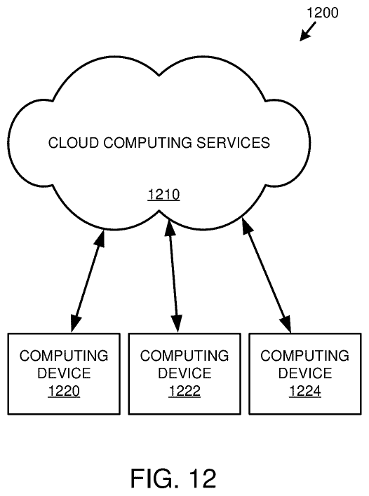

FIG. 12 depicts an example cloud computing environment 1200 in which the described technologies can be implemented. The cloud computing environment 1200 comprises cloud computing services 1210. The cloud computing services 1210 can comprise various types of cloud computing resources, such as computer servers, data storage repositories, networking resources, etc. The cloud computing services 1210 can be centrally located (e.g., provided by a data center of a business or organization) or distributed (e.g., provided by various computing resources located at different locations, such as different data centers and/or located in different cities or countries).

The cloud computing services 1210 are utilized by various types of computing devices (e.g., client computing devices), such as computing devices 1220, 1222, and 1224. For example, the computing devices (e.g., 1220, 1222, and 1224) can be computers (e.g., desktop or laptop computers), mobile devices (e.g., tablet computers or smart phones), or other types of computing devices. For example, the computing devices (e.g., 1220, 1222, and 1224) can utilize the cloud computing services 1210 to perform computing operators (e.g., data processing, data storage, and the like).

### Example 12—Implementations

Although the operations of some of the disclosed methods are described in a particular, sequential order for convenient presentation, it should be understood that this manner of description encompasses rearrangement, unless a particular ordering is required by specific language set forth herein. For example, operations described sequentially may in some cases be rearranged or performed concurrently. Moreover, for the sake of simplicity, the attached figures may not show the various ways in which the disclosed methods can be used in conjunction with other methods.

Any of the disclosed methods can be implemented as computer-executable instructions or a computer program product stored on one or more computer-readable storage media, such as tangible, non-transitory computer-readable storage media, and executed on a computing device (e.g., any available computing device, including smart phones or other mobile devices that include computing hardware). Tangible computer-readable storage media are any available tangible media that can be accessed within a computing environment (e.g., one or more optical media discs such as DVD or CD, volatile memory components (such as DRAM or SRAM), or nonvolatile memory components (such as flash memory or hard drives)). By way of example and with reference to FIG. 11, computer-readable storage media include memory 1120 and 1125, and storage 1140. The term computer-readable storage media does not include signals and carrier waves. In addition, the term computer-readable storage media does not include communication connections (e.g., 1170).

Any of the computer-executable instructions for implementing the disclosed techniques, as well as any data created and used during implementation of the disclosed embodiments, can be stored on one or more computer-readable storage media. The computer-executable instructions can be part of, for example, a dedicated software application or a software application that is accessed or downloaded via a web browser or other software application (such as a remote computing application). Such software can be executed, for example, on a single local computer (e.g., any suitable commercially available computer) or in a network environment (e.g., via the Internet, a wide-area network, a local-area network, a client-server network (such as a cloud computing network), or other such network) using one or more network computers.

For clarity, only certain selected aspects of the software-based implementations are described. Other details that are well known in the art are omitted. For example, it should be understood that the disclosed technology is not limited to any specific computer language or program. For instance, the disclosed technology can be implemented by software written in C++, Java, Perl, JavaScript, Python, Ruby, ABAP, Structured Query Language, Adobe Flash, or any other suitable programming language, or, in some examples, markup languages such as html or XML, or combinations of suitable programming languages and markup languages. Likewise, the disclosed technology is not limited to any particular computer or type of hardware. Certain details of suitable computers and hardware are well known and need not be set forth in detail in this disclosure.

Furthermore, any of the software-based embodiments (comprising, for example, computer-executable instructions for causing a computer to perform any of the disclosed methods) can be uploaded, downloaded, or remotely accessed through a suitable communication means. Such suitable communication means include, for example, the Internet, the World Wide Web, an intranet, software applications, cable (including fiber optic cable), magnetic communications, electromagnetic communications (including RF, microwave, and infrared communications), electronic communications, or other such communication means.

The disclosed methods, apparatus, and systems should not be construed as limiting in any way. Instead, the present disclosure is directed toward all novel and nonobvious features and aspects of the various disclosed embodiments, alone and in various combinations and sub combinations with one another. The disclosed methods, apparatus, and systems are not limited to any specific aspect or feature or combination thereof, nor do the disclosed embodiments require that any one or more specific advantages be present, or problems be solved.

The technologies from any example can be combined with the technologies described in any one or more of the other examples. In view of the many possible embodiments to which the principles of the disclosed technology may be applied, it should be recognized that the illustrated embodiments are examples of the disclosed technology and should not be taken as a limitation on the scope of the disclosed technology. Rather, the scope of the disclosed technology includes what is covered by the scope and spirit of the following claims.

What is claimed is:

1. A computing system comprising:
at least one memory;
one or more hardware processor units coupled to the at least one memory; and
one or more computer readable storage media storing computer-executable instructions that, when executed, cause the computing system to perform operations comprising:
receiving a first identifier value of a first user to be impersonated;
in a data store, assigning the first identifier value to a user impersonation variable;
receiving a query, the query accessing one or more data objects subject to data access controls, where the query is associated with a second identifier value of a user issuing the query, where the second identifier value is different from the first identifier value;
executing the query, the executing comprising using the first identifier value to filter query requests using data access controls specified for the first identifier value; and
returning filtered query results in response to the query.

2. The computing system of claim 1, wherein the data access controls specified for the first identifier value specify one or more values for an attribute of a data object of the one or more data objects.

3. The computing system of claim 1, the operations further comprising:
providing the first identifier value as an input parameter to a data object of the one or more data objects.

4. The computing system of claim 3, the operations further comprising:
based on receiving the first identifier value, instantiating the data object of the one or more data objects that comprises the input parameter from a data object that does not comprise the input parameter.

5. The computing system of claim 1, the operations further comprising:
establishing a session between an application and the data store, wherein the user impersonation variable is a session variable.

6. The computing system of claim 5, wherein the session provides an application user context.

7. The computing system of claim 1, the operations further comprising
providing the first identifier value to a data access control object;
by the data access control object, querying a permissions object to determine the data access controls specified for the first identifier value; and
by the data access control object, returning data access parameters of the permissions object for the first identifier value to be used in executing the query.

8. The computing system of claim 1, wherein the data access control object is a table function.

9. The computing system of claim 1, wherein the assigning the first identifier value is performed through a direct data store command.

10. The computing system of claim 1, the operations further comprising:
prior to filtering query results using data access controls specified for the first identifier, determining that a user associated with the second identifier value is authorized to cause the query to be executed by filtering query results using the first identifier value instead of the second identifier value.

11. The computing system of claim 1, wherein determining that a user associated with the second identifier value is authorized to cause the query to be executed by filtering query results using the first identifier value comprises determining that the user associated with the second identifier value is a schema owner or is a support user.

12. The computing system of claim 11, wherein at least a first data object of the one or more data objects accessed by the query is located in a first schema and at least a second data object of the one or more data objects accessed by the query is located in a second schema different from the first schema, and wherein executing the query comprises using the first identifier value only for data objects in a schema for which the user associated with the second identifier value is a schema owner.

13. The computing system of claim 11, wherein at least a first data object of the one or more data objects accessed by the query is located in a first schema and at least a second data object of the one or more data objects accessed by the query is located in a second schema different from the first schema, and wherein executing the query comprises using the first identifier value for all data objects of the one or more data objects.

14. The computing system of claim 1, the operations further comprising:
at an application in communication with the data store, setting the first identifier value;
adding the first identifier value to a header;
extracting the first identifier value from the header; and
using the first identifier value in establishing a connection between the application and the data store.

15. The computing system of claim 14, wherein using the first identifier value in establishing a connection between the application and the data store comprises setting a value of a session variable for the connection.

16. A method, implemented in a computing system comprising at least one hardware processor and at least one memory coupled to the at least one hardware processor, the method comprising:
receiving a first identifier value of a first user to be impersonated;
in a data store, assigning the first identifier value to a user impersonation variable;
receiving a query, the query accessing one or more data objects subject to data access controls, where the query is associated with a second identifier value of a user issuing the query, where the second identifier value is different from the first identifier value;
executing the query, the executing comprising using the first identifier value to filter query requests using data access controls specified for the first identifier value; and
returning filtered query results in response to the query.

17. The method of claim 16, further comprising:
providing the first identifier value as an input parameter to a data object of the one or more data objects; and
based on receiving the first identifier value, instantiating the data object of the one or more data objects that comprises the input parameter from a data object that does not comprise the input parameter.

18. The method of claim 16, further comprising:
establishing a session between an application and the data store, wherein the user impersonation variable is a session variable.

19. One or more non-transitory computer-readable storage media comprising:
computer-executable instructions that, when executed by a computing system comprising at least one hardware processor and at least one memory coupled to the at least one hardware processor, cause the computing system to receive a first identifier value of a first user to be impersonated;
computer-executable instructions that, when executed by the computing system, cause the computing system to, in a data store, assign the first identifier value to a user impersonation variable;
computer-executable instructions that, when executed by the computing system, cause the computing system to receive a query, the query accessing one or more data objects subject to data access controls, where the query is associated with a second identifier value of a user issuing the query, where the second identifier value is different from the first identifier value;
computer-executable instructions that, when executed by the computing system, cause the computing system to execute the query, the executing comprising using the first identifier value to filter query requests using data access controls specified for the first identifier value; and
computer-executable instructions that, when executed by the computing system, cause the computing system to return filtered query results in response to the query.

20. The one or more computer-readable storage media of claim 19, further comprising:
computer-executable instructions that, when executed by the computing system, cause the computing system to establish a session between an application and the data store, wherein the user impersonation variable is a session variable.
